(19) United States
(12) Patent Application Publication
(10) Pub. No.: US 2009/0061405 A1
(43) Pub. Date: Mar. 5, 2009

(54) DOLL WITH REVOLVING ABDOMINAL CHAMBER TO SIMULATE PREGNANCY

(75) Inventors: Beatrice Hallig, Santa Barbara, CA (US); Warren Dennis, Santa Barbara, CA (US)

Correspondence Address: FELIX L. FISCHER, ATTORNEY AT LAW, 1607 MISSION DRIVE, SUITE 204, SOLVANG, CA, 93463, US

(73) Assignee: MOMMY WITH A TUMMY TM, CORPORATION, Santa Barbara, CA (US)

(21) Appl. No.: 12/059,181

(22) Filed: Mar. 31, 2008

Related U.S. Application Data
(60) Provisional application No. 60/968,483, filed on Aug. 28, 2007.

(51) Int. Cl. G09B 23/00; A63H 13/02

(52) U.S. Cl. 434/267; 434/262; 446/296

(57) ABSTRACT

An abdominal torso element for a doll incorporates a receiving cavity with a first rotational element mounted in the torso element having an enlarged abdominal surface representing a pregnant abdomen and incorporating an associated fetal cavity. The first rotational element is positionable in a first closed position with the enlarged abdominal surface exterior to the torso element simulating pregnancy and a second open position with the enlarged abdominal surface received in the receiving cavity. A second rotational element is nested within the first rotational element and has an outer surface representing a non-pregnant abdomen. The second rotational element is positionable in a first open position and a second closed position with the non-pregnant abdominal surface exposed simulating a non-pregnant condition. A fetus/baby model is removably received within the fetal cavity and can be viewed and removed/inserted with the first and second rotational elements in the open position.

### REFERENCE TO RELATED APPLICATIONS

This application claims priority of U.S. provisional application Ser. No. 60/968,483 filed on Aug. 28, 2007 having the same title as the present application, the disclosure of which is incorporated herein by reference as though fully set forth.

### BACKGROUND OF THE INVENTION

1. Field of the Invention

This invention relates generally to the field of instructional toy dolls and more specifically to a doll containing an abdominal chamber with a nested multiple revolving structure to house a removable fetus model with a first enlarged abdomen simulating pregnancy and a second normal abdomen simulating a non-pregnant condition.

2. Description of the Related Art

Dolls are traditionally employed by children as toys for imaginative play. Female representations in dolls are often employed for role play and the state of the female body in pregnant and non-pregnant conditions is often desired by the child to add to the realism of the play. While anatomical models have been produced for educational purposes such as the Visible Woman® and “mommy dolls” are available with stretching pouches or other forms to simulate a pregnant condition as disclosed in U.S. Pat. No. 4,883,442 issued Nov. 28, 1989 to Kaplan entitled Pregnant Mother Doll and Separable Baby Doll and U.S. Pat. No. 5,207,728 issued May 4, 1993 to Fogerty et al. entitled Maternity Dress for a Doll which Simulates Pregnancy, a high quality doll which can realistically simulate a pregnant condition and can easily be converted from representing the pregnant state to a non-pregnant state has not been available.

It is therefore desirable to provide a doll which can realistically simulate the condition of a woman's body in both the pregnant and non-pregnant state with a removable fetus/baby for pre and post birth play scenarios.

### SUMMARY OF THE INVENTION

The present invention provides a doll having an abdominal torso element incorporating a receiving cavity with a first rotational element mounted in the torso element having an enlarged abdominal surface representing a pregnant abdomen and incorporating an associated fetal cavity. The first rotational element is positionable in a first closed position with the enlarged abdominal surface exterior to the torso element simulating pregnancy and a second open position with the enlarged abdominal surface received in the receiving cavity. A second rotational element is nested within the first rotational element and has an outer surface representing a non-pregnant abdomen. The second rotational element is positionable in a first open position and a second closed position with the non-pregnant abdominal surface exposed simulating a non-pregnant condition. A fetus/baby model is removably received within the fetal cavity and can be viewed and removed/inserted with the first and second rotational elements in the open position.

In an exemplary embodiment, the second rotational element has an inner surface with mounting posts to restrain the fetus/baby.

### BRIEF DESCRIPTION OF THE DRAWINGS

These and other features and advantages of the present invention will be better understood by reference to the following detailed description when considered in connection with the accompanying drawings wherein:

FIG. 1 is an isometric hidden view representation of the structural elements of the present invention;

FIG. 2 is a view of the embodiment of FIG. 1 with the pregnant abdomen in the closed state;

FIG. 3 is a view of the embodiment of FIG. 1 with the pregnant abdomen in an intermediate state between closed and open;

FIG. 4 is a view of the embodiment of FIG. 1 with the pregnant abdomen in the open position exposing the fetus/baby;

FIG. 5 is a view of the rear surface of the non-pregnant abdomen in the open state with the fetus/baby removed and showing exemplary supports for the fetus/baby;

FIG. 6 is a view of the embodiment of FIG. 1 with the non-pregnant abdomen in a first intermediate state substantially half way between open and closed;

FIG. 7 is a view of the embodiment of FIG. 1 with the non-pregnant abdomen in a second intermediate state approaching closed; and,

FIG. 8 is a view of the embodiment of FIG. 1 with the non-pregnant abdomen in the closed position.

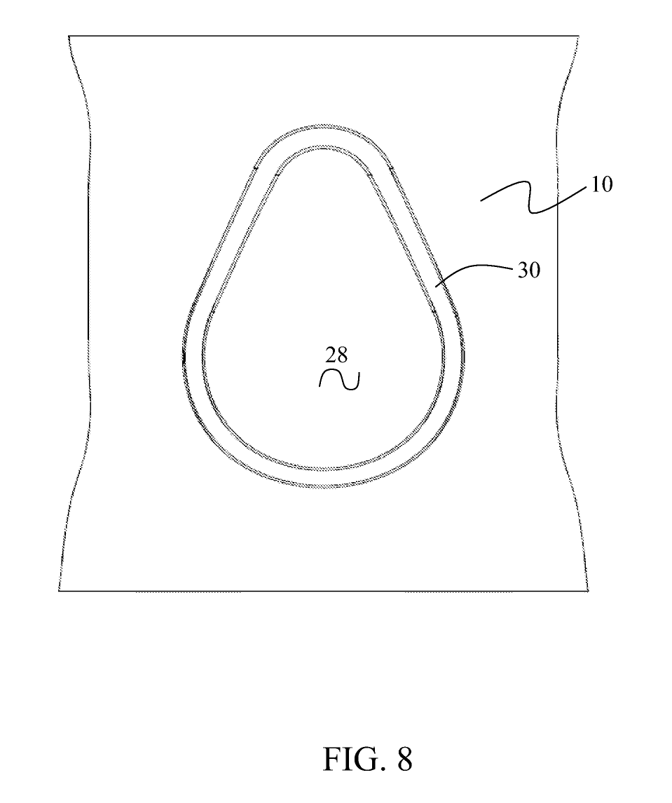

### DETAILED DESCRIPTION OF THE INVENTION

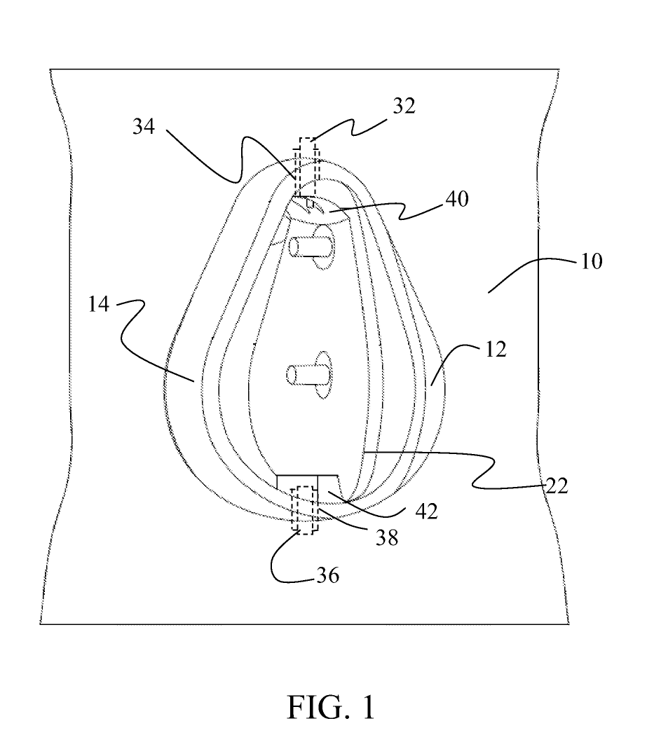

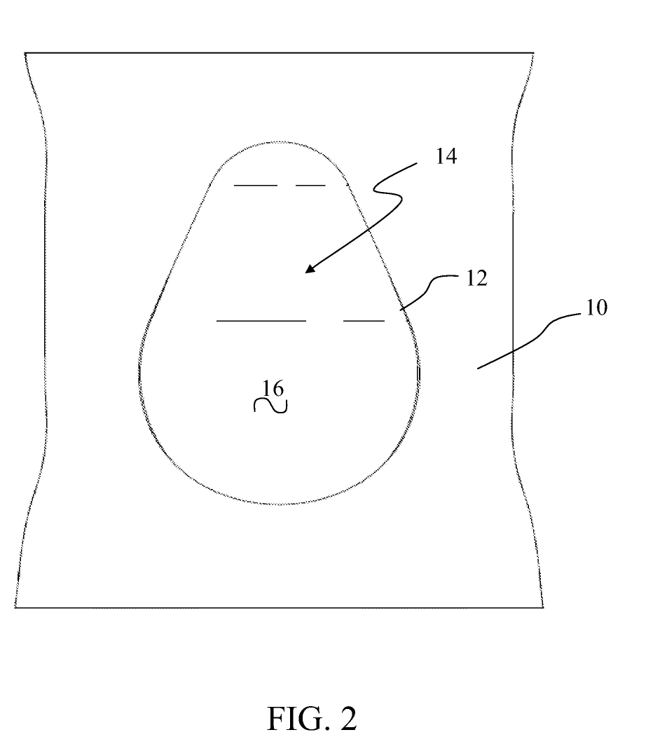

Referring to the drawings, FIG. 1 shows the structure of a nested rotational element arrangement incorporating the present invention. The general abdominal torso 10 of the doll includes a receiving cavity 12 within the torso. As also seen in FIGS. 2, 3 and 4, a first rotational element 14 representing the pregnant abdomen incorporates an enlarged abdominal surface 16 and associated fetal cavity 18 which is sized to contain a representation of a fetus/baby 20. In a first closed position, the first rotational element extends outwardly covering the receiving cavity and presenting the enlarged abdominal surface on the general abdominal area of the doll to simulate the pregnant condition as shown in FIG. 2. The outer enlarged abdominal surface substantially covers the receiving cavity for a realistic appearance of the pregnant abdomen for the doll.

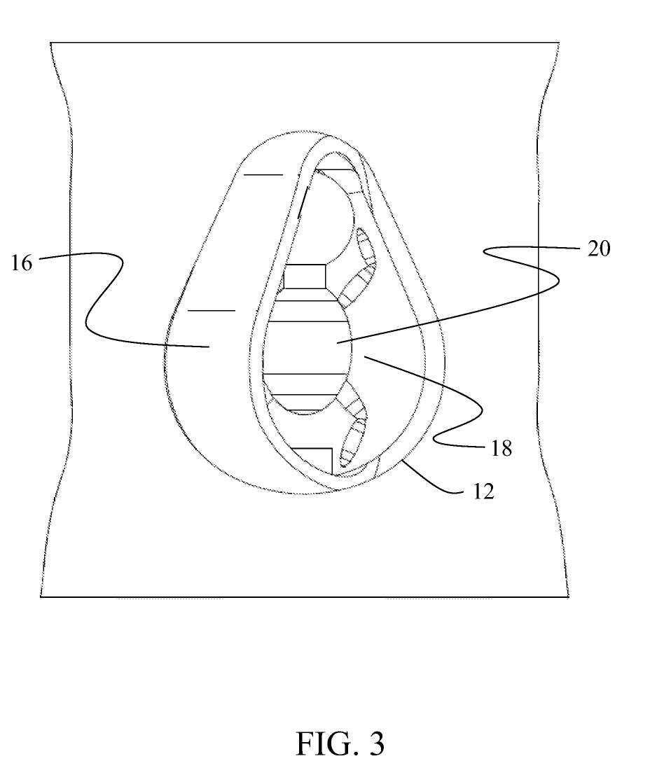

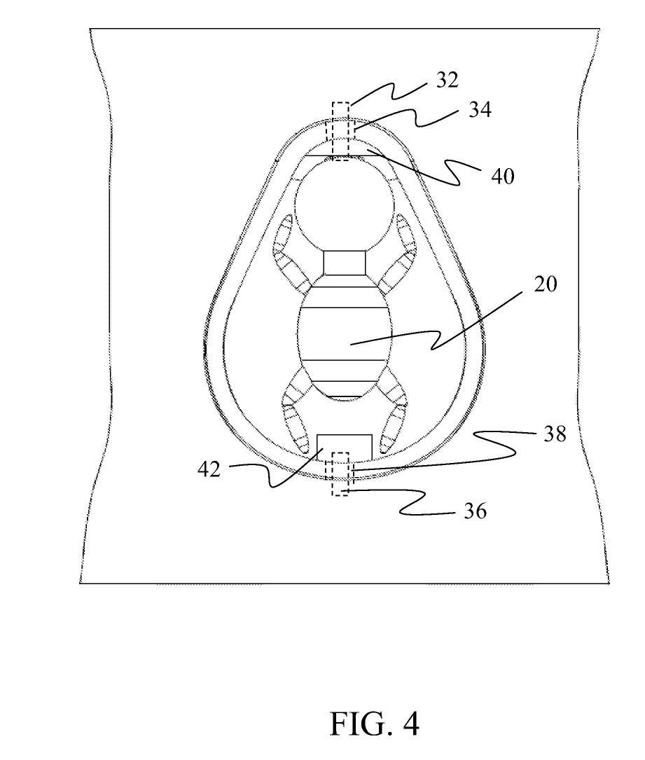

The first element is rotatable as shown in FIG. 3 with the enlarged abdominal surface rotating into the receiving cavity to expose the fetus/baby. In the fully rotated open second position of the first element as shown in FIG. 4, the fetus/baby is fully exposed and can be removed.

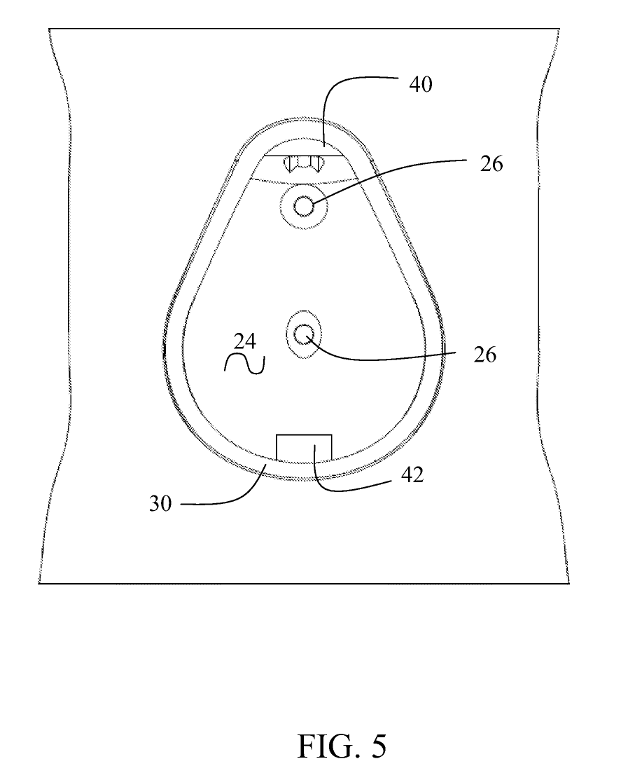

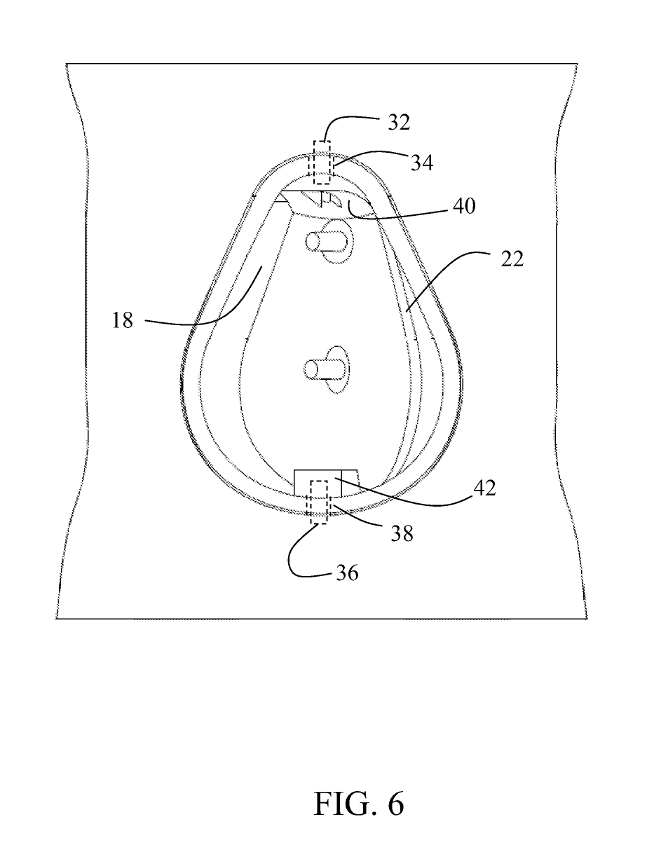

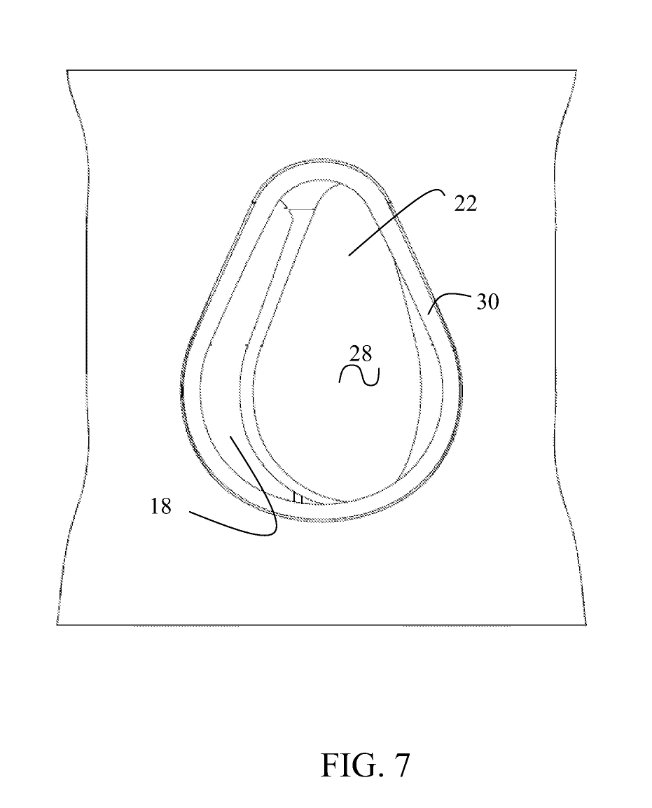

A second rotational element 22 representing the non-pregnant abdomen is nested within the first rotational element as seen in FIG. 5 in an open first position. In the first position, an inner surface 24 of the second rotational element incorporates securing posts 26 which engage mating holes in the fetus/baby to constrain the fetus/baby in the cavity created by the first rotational element for the embodiment disclosed in the drawings. Rotation of the second rotational element as shown in FIG. 6 exposes an outer surface 28 representing a non-pregnant abdomen. In the fully rotated closed second position shown in FIG. 7, the second rotational element is received within a rim 30 of the first rotational element providing a substantially complete abdominal surface for the doll in the non-pregnant state.

The first and second rotational elements are pinned along a vertical axis for rotation within the receiving cavity. As best seen in FIGS. 1, 4 and 7, an upper stud 32 extends through an upper bore 34 and a lower stud 36 extends through a lower bore 38 in the first rotational element. An upper cup 40 extending from the upper periphery of the second rotational element is receive over the end of the upper stud and a lower cup 42 extending from the lower periphery of the second rotational element is received over the end of the lower stud securing the second rotational element and capturing the first rotational element on the studs.

The fetus/baby is fully accommodated in the fetal cavity in the first rotational element. The fetus/baby can be removed with the first and second rotational elements both in the open position, however, the receiving cavity provides sufficient volume to receive the pregnant abdomen surface of the first rotational element allowing the fetus/baby to remain in place with the non-pregnant abdomen of the second rotational element in the closed position. The torso of the doll only requires sufficient depth to accommodate the volume of the pregnant abdomen in the open position. This allows the fetus/baby to be retained within the doll for either the pregnant or non-pregnant representation for storage or to prevent loss while retaining a realistic body shape for the torso of the doll.

For the embodiment shown, single opposing studs on a vertical axis at the upper and lower ends of the receiving cavity capture the first and second rotational elements. In alternative embodiments, a dimple and cup arrangement at the top and bottom of both rotational elements allows a snap fit insertion of the nested elements.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A structure for simulating pregnant and non-pregnant states in a doll comprising:
an abdominal torso element incorporating a receiving cavity;
a first rotational element mounted in the torso element having an enlarged abdominal surface representing a pregnant abdomen and incorporating an associated fetal cavity, the first rotational element positionable in a first closed position with the enlarged abdominal surface exterior to the torso element simulating pregnancy and a second open position with the enlarged abdominal surface received in the receiving cavity;
a second rotational element nested within the first rotational element having an outer surface representing a non-pregnant abdomen, the second rotational element positionable in a first open position and a second closed position with the non-pregnant abdominal surface exposed simulating a non-pregnant condition; and,
a fetus/baby removably received within the fetal cavity.

2. The structure for simulating pregnant and non-pregnant states in a doll as defined in claim 1 wherein the second rotational element has an inner surface with mounting means to restrain the fetus/baby.

3. The structure for simulating pregnant and non-pregnant states in a doll as defined in claim 1 wherein
the torso element incorporates studs in opposed relation proximate the receiving cavity;
the first rotational element incorporates bores receiving the studs for rotational mounting; and,
the second rotational element incorporates cups received over an end of each stud for rotational mounting.

4. A structure for simulating pregnant and non-pregnant states in a doll comprising:
an abdominal torso element incorporating a receiving cavity and having studs in opposed relation proximate a top and a bottom of a receiving cavity;
a first rotational element mounted in the torso element having an enlarged abdominal surface representing a pregnant abdomen and incorporating an associated fetal cavity, the first rotational element positionable in a first closed position with the enlarged abdominal surface exterior to the torso element simulating pregnancy and a second open position with the enlarged abdominal surface received in the receiving cavity, the first rotational element incorporating bores receiving the studs for rotational mounting;
a second rotational element nested within the first rotational element having an outer surface representing a non-pregnant abdomen and an inner surface with mounting means, the second rotational element positionable in a first open position and a second closed position with the non-pregnant abdominal surface exposed simulating a non-pregnant condition, the second rotational element incorporating cups received over an end of each stud for rotational mounting; and,
a fetus/baby removably received within the fetal cavity and securable to the mounting means.

5. A method for simulating pregnant and non-pregnant states in a doll comprising the steps of:
providing an abdominal torso element incorporating a receiving cavity;
mounting a first rotational element in the torso element having an enlarged abdominal surface representing a pregnant abdomen and incorporating an associated fetal cavity;
mounting a second rotational element nested within the first rotational element having an outer surface representing a non-pregnant abdomen;
positioning the first rotational element positionable in a first closed position with the enlarged abdominal surface exterior to the torso element simulating pregnancy;
positioning the second rotational element in a first open position with a fetus/baby removably attached to the second rotational element and received within the fetal cavity
positioning the first rotational element in a second open position with the enlarged abdominal surface received in the receiving cavity and,
positioning the second rotational element in a second closed position with the non-pregnant abdominal surface exposed simulating a non-pregnant condition.

6. The method for simulating pregnant and non-pregnant states in a doll of claim 5 further wherein the step of providing a second rotational element includes providing a an inner surface with mounting means to restrain the fetus/baby on the second rotational element.

7. The method for simulating pregnant and non-pregnant states in a doll of claim 6 further comprising the step of removing the fetus/baby from the mounting means prior to the step of positioning the second rotational element in a second closed position.

8. The method for simulating pregnant and non-pregnant states in a doll of claim 5 wherein the step of providing an abdominal torso element further includes incorporating studs in opposed relation proximate the receiving cavity, the step of mounting a first rotational element includes incorporating bores in the first rotational element for receiving the studs for rotational mounting, and the step of mounting a second rotational element includes incorporating cups in the second rotational element received over an end of each stud for rotational mounting.
